(19) United States
(12) Patent Application Publication
(10) Pub. No.: US 2009/0207638 A1
(43) Pub. Date: Aug. 20, 2009

(54) Gadgets generators

(76) Inventor: James Garrett Sams, Locust Grove, GA (US)

Correspondence Address: James Garrett Sams, 221 Highland Dr., Locust Grove, GA, 30248, US

(21) Appl. No.: 12/008,030

(22) Filed: Feb. 14, 2008

(51) Int. Cl. H02P 11/06; H02K 53/00

(52) U.S. Cl. 363/102; 415/916

(57) ABSTRACT

This invention boost the original power source to help or cut down the usage of public Power sources.

(Generator) This is an electric motor driven generator. Input, The generator must rotate at 3600 RPMS. Rotating either clockwise or counter clockwise. Output (can very) from 1000 watts and up. Voltage ratings can also very 120 volts, 240 volts. Amps. Will very depending on watt rating. @50 hrts. & 60 hrts.

(Electric Motor) ¾ Hp and up, (RPMS) between 3450 3600 RPMS. Voltage rating 115/220 v. @60 hz. Continuous duty.

(See FIG. 2. of drawings)

(Pulleys or Gears) Are determined by a formula.

$$\frac{Engine speed ( rpms )}{Generator speed 3600 rpms} = \frac{Pulley diameter ( generator )}{pulley diameter ( engine )}$$

(Belts) (See FIG. 2. of drawings)

Will very in size along with pulley size and distance of motor and generator.

(Gears) (See FIG. 5. of drawings)

Gear ratio will depend on motors rpms, and number of teeth on gears.

### BRIEF DESCRIPTION OF DRAWINGS VIEWS

FIG. 1.

Shows where the generator is being turned by a pulley and belt, Method, with an electric motor,they are side by side,with a base mounting.

FIG. 2.

Is the facing view of the pulleys and belt.

FIG. 3.

Shows the motor in an off set position facing the generator, with The gears connecting and turning each other.

FIG. 4.

Shows the motor facing the generator in a direct facing fashion using a transion coupling, in this case the motors rpms must be the same as the generators.

FIG. 5.

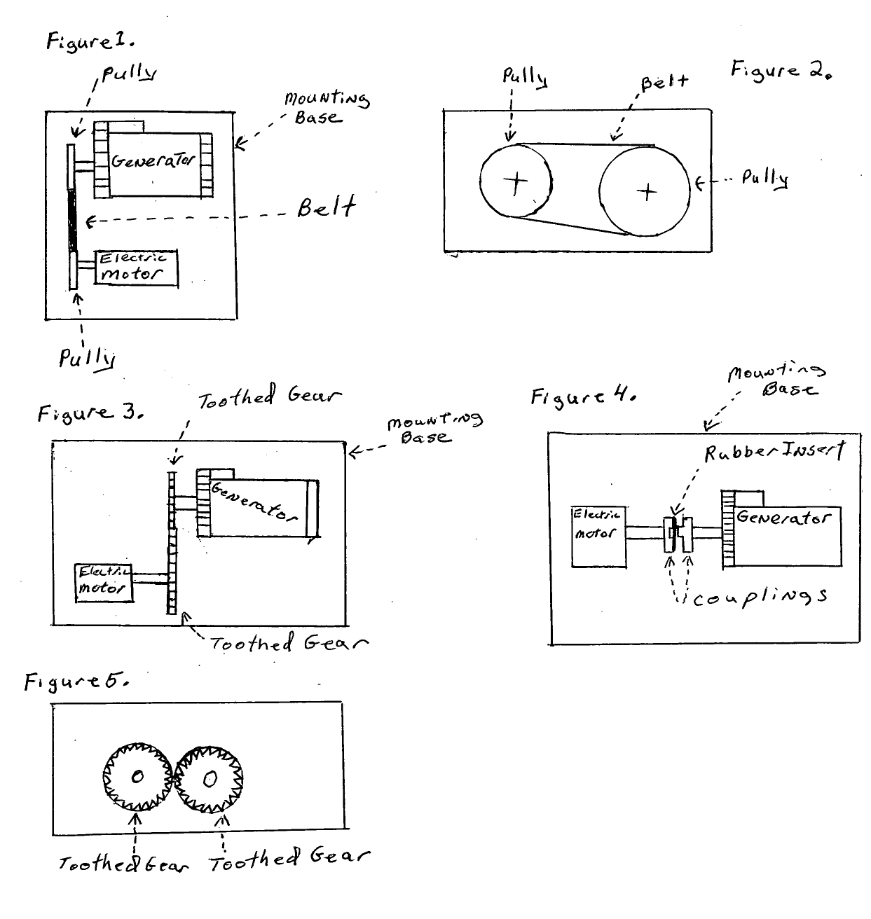

Shows two gears of FIG. 3.

1. I James Garrett Sams claim that this is an original Idea of My own creation and design. In regards to the GADGETS GENERATOR, which is a generator driven by The use of a electric motor.
